(19) United States
(12) Patent Application Publication
(10) Pub. No.: US 2018/0043729 A1
(43) Pub. Date: Feb. 15, 2018

(54) TOY AND METHOD OF OPERATION

(71) Applicant: ROLANDO PEREZ, MIRAMAR, FL (US)

(72) Inventor: ROLANDO PEREZ, MIRAMAR, FL (US)

(21) Appl. No.: 15/234,041

(22) Filed: Aug. 11, 2016

(51) Int. Cl. B43K 29/00; A63H 1/32; B43K 29/20

(52) U.S. Cl. CPC B43K 29/00; B43K 29/20; A63H 1/32

(57) ABSTRACT

A toy and method of operation provides: a marking instrument for marking on a substrate, a container for containing candy or medicine or a toy; and a spinning toy for entertainment. The toy comprises a marking device defined by a mark end and a cap end, with the cap end having a circular flange. The toy also comprises a dispenser for containing candy, medicine, or a toy. A toy portion separates into a first toy member, a central spinner, and a second toy member. A cord extends between the first and second toy members, passing through a channel in central spinner. Twisting the cord in a first direction generates torque, causing the central spinner to be rotatably carried towards the first toy member. Twisting the cord in a second direction releases momentum from the generated torque, rotatably carrying the central spinner towards the second toy member.

### BACKGROUND

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The present invention is directed to a toy and method of operation that provides the multi-functional uses of: a writing instrument for marking a substrate; a container for containing candy or medicine or toy; and a spinning toy for entertainment.

The inventor of the present invention has extensive experience with toys, and especially traditional mechanical toys. The inventor recognized that in the modern world, children are more prone to playing with digital games than with physical products. The inventor realized that he somehow had to again teach a child to play with physical products, for physical products develop coordination and physical skills that a digital game could never offer the child.

The inventor was also aware that a marking instrument, such as a pen, a pencil, or a crayon was often useful and fun to have when playing. The writing instrument could also increase interest in the toy that the inventor had in mind. The inventor wondered if it was possible to combine a writing instrument, a container of candy, medicine, and toys, and a spinning toy.

He remembered that in his youth he played with a toy that is similar to the toy described in U.S. Pat. No. 2,161,154 that was issued to I. Gertler. A simple toy that allowed children to grasp the extremities of a toy and manipulate the toy so that the toy could spin along a central axis. The toy was manipulated by the child in the manner described in the Gertler patent. The present invention uses at least a portion of the mechanism of the Gertler patent.

The inventor recognized a problem in that the spinning motion of the toy required mechanical energy to operate efficiently. The inventor knew that when a cord was twisted in a first direction, torque and momentum were built up within the cord. And when the cord was released, the momentum forced the cord to twist in an opposite direction.

The inventor decided to use this phenomena to enable a cylindrically shaped central spinner to move along the length of the cord from extreme ends of the toy. The cord could also be drawn taut or slackened to change the angular and linear velocity of the spinning central spinner. This manipulation of the cord provided a challenging exercise that enhanced motor skills and provided entertainment.

The inventor recognized another problem in that the toy had to be more alluring for a child, going beyond just a spinning toy. The inventor devised a manner of introducing a physical spinning toy to a child in a manner in which the child would not be led to believe that he was being forced to play with a physical product. The physical product would then serve to increase the child's motor skills. By housing an edible member, such as candy or gum, in the center of the toy and allowing the edible member to spin, the child would be swayed fascinated by the spinning motion and the edible member; thereby causing the child to purchase the toy. Further, after the edible member is consumed, the inventor believes that the child would eventually use the dispenser as a toy.

Writing instruments and spinning toys and candy surprises have been utilized in the past; yet none with the characteristics of the present invention. See U.S. Pat. Nos. 1,804,260; 2,161,154; 7,531,197; and 20100028068.

For the foregoing reasons, there is a toy and method of operation that is configured into a multi-functional spinning toy; writing instrument; and a food and toy container. Specifically, the device is configured to operate as: 1) a spinning toy for providing entertainment and developing motor skills; 2) a writing instrument for marking on a substrate; and 3) a dispenser for containing a candy or a medicine or a toy.

### SUMMARY

The present invention describes a toy and method of operation that offers multi-functionality, including operation as: a spinning toy for providing entertainment and developing motor skills; a container for containing a candy, or a medicine, or a toy; and a marking instrument for marking on a substrate.

In one embodiment, the toy comprises a simple to operate spinning toy that leverages the torque generated from twisting a cord, and the momentum released from the cord to create a spinning motion across a central spinner towards extreme ends of a dispenser. The angular velocity and the linear velocity of the spinning and linear motion can be regulated through manipulation of the cord. The cord is preloaded and wound up during packaging, such that the toy spins when initially opened.

The toy further comprises a generally elongated dispenser having a tubular shape. The dispenser comprises a cavity that forms a useful container to enable candy, a medicine, or a toy to be stored, carried, and dispensed. The dispenser is defined by a mark end and a cap end. The cap end comprises a circular flange. The mark end and the cap end of the dispenser detachably mate through a threaded engagement.

The toy further provides a marking device. The marking device is configured to produce a mark. In some embodiments, the marking device may include, without limitation, a solid pigment core, a solid wax core, or an ink dispenser.

The first toy member is defined by a first end wall, a first continuous sidewall, and a circular recess. The central spinner may have a generally cylindrical shape and be defined by a middle continuous sidewall with a transversely disposed wall having a channel. The channel enables passage of a cord for spinning the central spinner; thereby serving as a spinning toy. The central spinner also adds weight to the cord, so that the angular velocity and linear velocity increases during spinning.

The second toy member is defined by a second end wall and a second continuous sidewall. At least one gate may form at the end walls or continuous sidewalls.

A cord extends between the first end wall of the first toy member and the second end wall of the second toy member. The cord also concentrically passes through the channel in the central spinner. The cord carries the central spinner so as to rotate along the axis of the cord. The central spinner is also configured to move freely in two directions along the length of the cord.

In operation of the toy as a writing instrument, the marking device is bifurcated into a mark end and a cap end that detachably mate. The shape of the marking device is elongated and tubular to provide a comfortable writing grip. The mark end leaves a pigment or ink on a substrate, based on the direction and pressure that the marking device is manipulated.

In operation of the toy as a container, the dispenser comprises a cavity for containing a candy, or a medicine, or a toy. The candy or medicine or toy may be accessed through the at least one gate that forms in the first end wall or the first continuous sidewall of the first or second toy members.

In operation of the toy as a spinning toy, the cord may be manipulated to twist in two directions. As the cord twists in a first direction, the central spinner rotates, and is carried along the length of the cord towards the first or second toy member, depending on the direction of the twisting by the cord. The twisting action in the first direction creates torque in the cord, which carries the central spinner lengthwise along the cord, either towards the first toy member or towards the second toy member.

After twisting in the first direction, momentum gained by the cord and the weight of the central spinner force the cord to twist in a second direction; thereby causing the central spinner to move lengthwise along the cord in an opposite direction. The angular velocity and the linear velocity of the central spinner about the cord may be increased by manipulating the cord to draw the cord taut, or decreased by manipulating the cord to slacken the cord.

In one aspect of the present invention, the dispenser has an elongated barrel shape.

In another aspect, the central spinner has a generally cylindrical shape.

In another aspect, the first toy member and the second toy member have a generally frustoconical shape.

In another aspect, the first continuous sidewall has a first beveled edge.

In another aspect, the second continuous sidewall has a second beveled edge configured to mate with the first beveled edge.

In another aspect, the dispenser is configured to contain at least one member selected from the group consisting of: a hard candy, a gum, a chocolate, a medicine, a tablet, and a small toy.

In another aspect, the at least one gate slidably moves between an open position and a closed position.

In another aspect, the cord is configured to form a continuous loop.

In another aspect, the central spinner is rotatably carried towards the first toy member and the second toy member at an angular velocity and a linear velocity.

In another aspect, the angular velocity and a linear velocity of the central spinner is increased by drawing the cord taut.

In another aspect, the angular velocity and a linear velocity of the central spinner is decreased by slackening the cord.

In some embodiments, a method for operating a toy comprises an initial Step of containing a candy or a medicine or a toy in a cavity of a dispenser. A Step may also include dispensing the candy or the medicine or the toy through at least one gate of the dispenser. A further Step comprises separating the toy into a first toy member, a central spinner, and a second toy member.

In some embodiments, a Step may include extending a cord between the first toy member and the second toy member. A Step comprises passing the cord through a channel in the central spinner. A further Step includes twisting the cord in a first direction to generate torque and rotatably carry the central spinner towards the first toy member. Another Step may include twisting the cord in a second direction to release momentum from the generated torque and rotatably carry the central spinner towards the second toy member.

One objective of the present invention is to provide an entertaining spinning toy.

Another objective of the present invention is to provide a dispenser that contains candy or medicine.

Another objective of the present invention is to regulate access to the candy or medicine through at least one gate.

Yet another objective of the present invention is to generate sufficient torque on a cord, such that the central spinner are rotatably carried to the first toy member or the second toy member.

Yet another objective is to release momentum from the generated torque, such that the central spinner are rotatably carried towards the second toy member.

Yet another objective is to consume the contents of the dispenser either after or before playing with the device.

Yet another objective is to enable the cord to be manipulated so that the angular velocity and linear velocity of the central spinner is increased or decreased.

Yet another objective of the present invention is to provide a candy or pill dispenser that converts into a toy after the candy or pill is consumed.

Another objective of the present invention is to provide a physical toy to a child that will allow the child to improve his or her motor skills.

Yet another objective of the present invention is to provide a child with a non-digital toy or game.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### DRAWINGS

These and other features, aspects, and advantages of the present invention will become better understood with regard to the following description, appended claims, and drawings where:

FIG. 1 is a perspective view of an exemplary toy;

FIG. 2 is a perspective view of the toy, shown in FIG. 1, where a first toy member, a second toy member, and a central spinner are separated;

FIG. 3 is a perspective view of an exemplary toy separated into a first toy member, a second toy member, and a central spinner;

FIG. 4 is a perspective view of the dispenser shown in FIG. 3, where the first toy member, the second toy member, and the central spinner are fully extended and rotating on a cord, and where the central spinner is carried towards the first toy member on a cord;

FIG. 5 is a perspective view of the toy, shown in FIG. 1, where the dispenser is screwed off the marking device;

FIG. 6 is a perspective view of the toy, shown in FIG. 1, where the dispenser is fully extended from the marking device; and

FIG. 7 is a perspective view of the marking device separated into a mark end and a cap end, and detached from a first toy member.

### DESCRIPTION

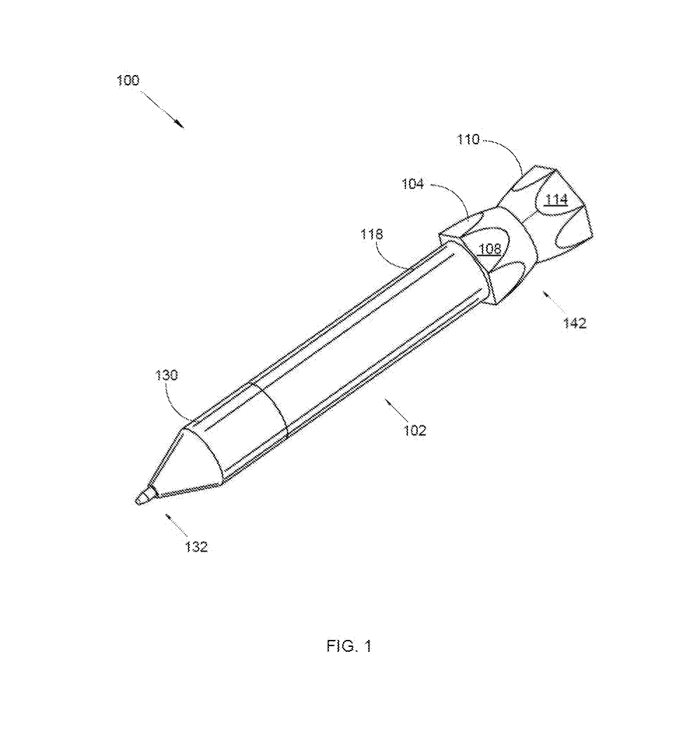

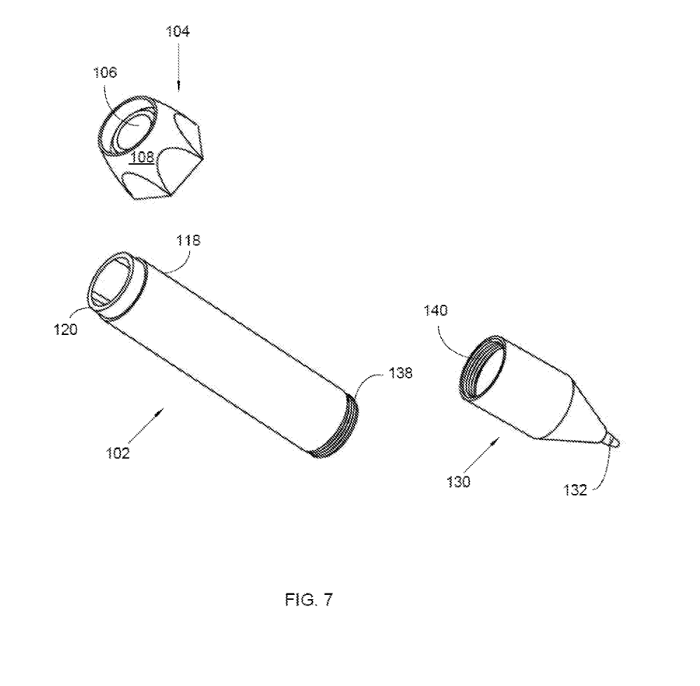

The present invention is directed to a toy 100 and method of operation, as referenced in FIGS. 1-7. The toy 100, hereafter “toy 100” provides the multi-functional use of a marking instrument, a storage and dispensing container, and a spinning toy. Specifically, the toy 100 is configured to operate as: 1) a spinning toy for providing entertainment and developing motor skills; 2) a writing instrument for marking on a substrate; and 3) a container for containing a candy or a medicine or a toy.

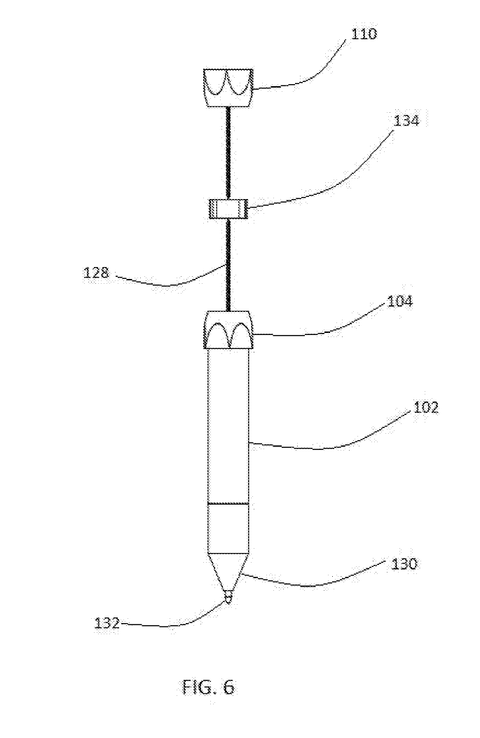

Looking at FIG. 6, the toy 100, as utilized as a spinning toy, provides a simple to operate spinning toy that leverages the torque generated from twisting a cord 128, and the momentum released from the cord 128 to spin a central spinner 134 towards extreme ends of a dispenser 102. The angular velocity and the linear velocity of the spinning motion by the central spinner 134 may be increased or decreased by manipulating the cord 128, i.e., draw the cord 128 taut or slacken the cord 128. The cord 128 is preloaded, i.e., wound up during packaging, such that the toy spins when initially opened. This manipulation of the cord 128 helps develop motor skills and also provides entertainment. Suitable materials for the toy 100 may include, without limitation, a rigid polymer, polyurethane, a metal, wood, and fiberglass.

The toy 100, as utilized as a dispenser 102, enables facilitated gripping for writing characters on paper or similar substrate. The toy 100, as utilized as a container provides a useful attachment to the dispenser 102 that can store, carry, and dispense a variety of edible items and toys. In one embodiment, a dispenser 102 detachably mates with the dispenser 102. The dispenser 102 securely and safely contains candy and medicine for storage, portability, refilling, and dispensing. The candy and medicine may be filled and dispensed through at least one gate (not shown) in the dispenser 102. The candy and medicine may also be filled and dispensed by disassembling the dispenser 102.

As referenced in FIG. 1, the edible spinning toy 100 comprises a generally elongated dispenser 102 defined by a mark end 130 and a cap end 118. The cap end 118 comprises a circular flange 120. The mark end 130 attaches to a marking device 132 that is configured to produce a mark on a substrate, such as paper or a chalkboard. In some embodiments, the marking device 132 may include, without limitation, a solid pigment core, a solid wax core, or an ink dispenser.

In one embodiment, the mark end 130 and the cap end 118 of the dispenser 102 detachably mate through a threaded engagement between a first threaded section 138 of the cap end 118 and a second threaded region 140 of the mark end 130—generally at the terminus of each end 118, 130. Though in other embodiments, the mark end 130 and the cap end 118 may detachably mate through other means, including through a friction-fit mechanism, a magnet, or an adhesive.

At least one gate may form at the dispenser 102. The gate may slide or hinge between an open position and a closed position. The open position enables the candy and the medicine to be dispensed or filled in the cavity 116 of the dispenser 102.

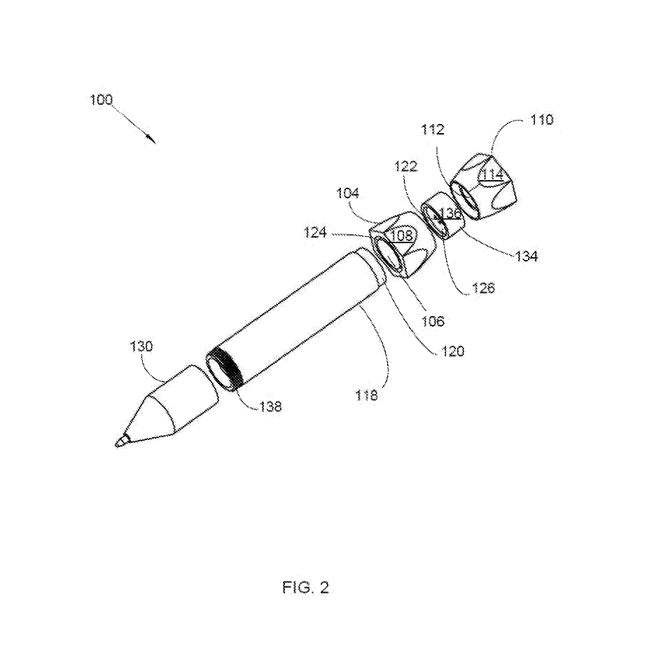

Turning now to FIG. 2, the toy 100 may further include a toy portion 142 that detachably mates with the dispenser 102. The toy portion 142 separates into a first toy member 104, a central spinner 134, and a second toy member 110. In one embodiment, the toy portion 142 may have a generally barrel shape. Though in other embodiments, a triangular or multi-faceted shape may be used for the toy portion 142.

The first toy member 104, central spinner 134, and second toy member 110 are configured to both, come together to form the toy portion 142, or separate and work in conjunction with a cord 128 to operate as a spinning toy. The central spinner 134 is disposed between the first and second toy members 104, 110, forming a bridge therebetween.

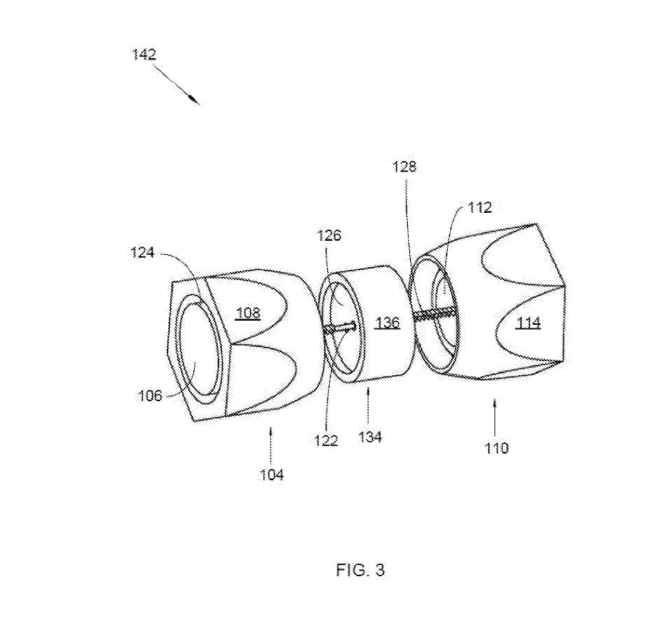

As FIG. 3 illustrates, the first toy member 104 is defined by a first end wall 106 and a first continuous sidewall 108. The first toy member 104 is further defined by a circular recess 124 that detachably couples to the circular flange 120 of the dispenser 102. The circular recess 124 may receive the circular flange 120 of the dispenser 102 in a friction-fit relationship to enable the detachable mating between the dispenser 102 and the dispenser 102.

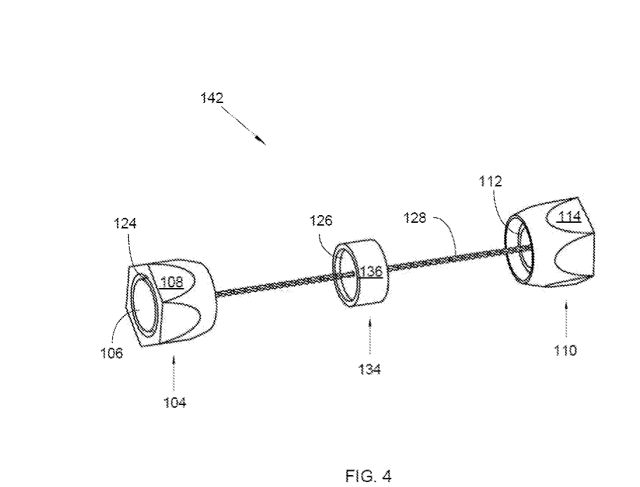

As FIG. 4 shows, the second toy member 110 is disposed opposite the first toy member 104, and is defined by a second end wall 112 and a second continuous sidewall 114. The second toy member 110 is shaped and sized substantially the same as the first toy member 104.

In some embodiments, the central spinner 134 may have a generally cylindrical shape and have sufficient weight to create momentum when spinning about a cord 128. The central spinner 134 is defined by a middle continuous sidewall 136 and a transversely disposed wall 126 having a channel 122.

The toy members 104, 110 may have beveled edges to facilitate connections therebetween. For example, the first continuous sidewall 108 has a first beveled edge and the second continuous sidewall 114 has a second beveled edge that is configured to mate with a pair of middle wall beveled edges in a snap-fit engagement.

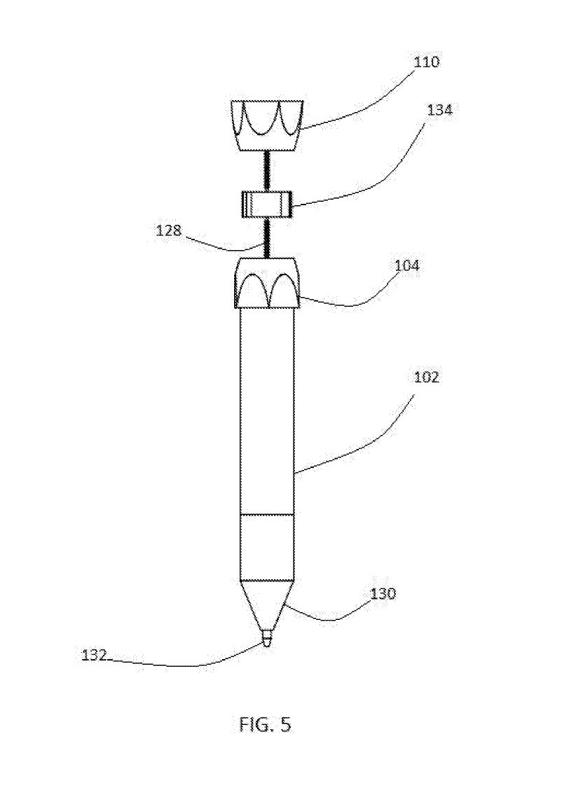

In some embodiments, the first toy member 104 and the second toy member 110 may have a generally frustoconical shape (FIG. 5). In yet another embodiment, the central spinner 134 has a generally cylindrical shape. Though in other embodiments, the toy members 104, 110 and the central spinner 134 may be shaped in other sizes and dimensions. In some embodiments, each of the toy members 104, 110 and the central spinner 134 may have a different color or pattern to provide greater entertainment value.

Turning now to FIG. 6, a cord 128 extends between the first end wall 106 of the first toy member 104, and the second end wall 112 of the second toy member 110. Each end of the cord 128 may fasten securely to the respective end wall 106, 112 through at least one anchor, or other fastening mechanism known in the art. The cord 128 also concentrically passes through the channel 122 in the central spinner 134.

As FIGS. 3-4 show, the cord 128 forms a continuous loop between the toy members 104, 110. In this case two parallel lengths of the cord pass through the channel 122. Suitable materials for the cord 128 may include, without limitation, a fiber, rubber, polyester, bamboo, and a polymer.

The cord 128 is also configured to twist in a first direction so as to generate torque and gain momentum. The momentum on the cord 128 is released when the cord 128 twists in the second direction. The cord 128 may be manipulated to alter the velocity of the spinning. The central spinner 134 is configured to rotate along the axis of the cord 128. The central spinner 134 is also configured to move freely in two directions along the length of the cord 128. As the cord 128 twists in the first or second direction, the central spinner 134 is carried in either direction, dependent on the direction of the twisting motion.

It is significant to note that the cord 128 is preloaded during manufacture. The cord 128 is twisted ion the first direction, such that the toy portion 142 spins when initially opened.

In operation of the toy 100 as a writing instrument, the marking device 132 leaves a pigment or ink on a substrate, based on the direction and pressure that the dispenser 102 is manipulated. The marking device 132 may include, without limitation, a pencil, a pen, a crayon, and a marker. Any assortment of ink or pigment colors may be used.

In operation of the toy 100 as a container, the dispenser 102 comprises a cavity 116 for securely containing a candy, or a medicine, or toy. The candy or medicine may be filled into the cavity 116, or depositing the candy or medicine into the cavity 116 by removing the toy portion 142 from the dispenser 102.

In operation of the toy 100 as a spinning toy, the cord 128 may be manipulated to twist in two directions. As the cord 128 twists in a first direction, the central spinner 134 rotates and is carried along the length of the cord 128 towards the first or second toy members 104, 110, depending on the direction of the twisting by the cord 128. The twisting action in the first direction creates torque in the cord 128, which carries the central spinner 134 lengthwise along the cord 128, either towards the first toy member 104 or towards the second toy member 110.

After twisting the cord 128 in the first direction, momentum gained by the cord 128 and the weight of the central spinner 134 force the cord 128 to twist in a second direction. This causes the central spinner 134 to move lengthwise along the cord 128 in an opposite, second direction. The angular velocity and the linear velocity of the central spinner 134 about the cord 128 may be increased by drawing the cord 128 taut, or decreased by slackening the cord 128.

A method for operating a toy 100 enables the utilization of the toy 100 as: a spinning toy; a marking instrument for marking on a substrate, and a container for containing candy or medicine or a toy. The method comprises an initial Step of containing a candy or a medicine or toy in a cavity 116 of a dispenser 102. The toy 100, as used as a container, provides a dispenser 102 that securely and safely contains candy and medicine for storage, portability, refilling, and dispensing.

A Step may also include dispensing the candy or medicine or toy.

A further Step comprises separating a toy portion 102 into a first toy member 104, a central spinner 134, and a second toy member 110. The first toy member 104, central spinner 134, and second toy member 110 are configured to both, come together to form the dispenser 102, or separate and work in conjunction with the cord 128 to operate as a spinning toy. The central spinner 134 is disposed between the first and second toy members 104, 110, forming a bridge therebetween.

In some embodiments, a Step may include extending a cord 128 between the first toy member 104 and the second toy member 110. A Step comprises passing the cord 128 through a channel 122 in the central spinner 134. The cord 128 extends between the first end wall 106 of the first toy member 104, and the second end wall 112 of the second toy member 110. Each end of the cord 128 may fasten securely to the respective end wall 106, 112 through at least one anchor or other fastening mechanism known in the art. The cord 128 also concentrically passes through the channel 122 in the central spinner 134.

A further Step includes twisting the cord 128 in a first direction to generate torque and rotatably carry the central spinner 134 towards the first toy member 104. A final Step may include twisting the cord 128 in a second direction to release momentum from the generated torque and rotatably carry the central spinner 134 towards the second toy member 110.

While the inventor's above description contains many specificities, these should not be construed as limitations on the scope, but rather as an exemplification of several preferred embodiments thereof. Many other variations are possible. For example, the toy 100 may utilize two central spinners adjacent to each other. Accordingly, the scope should be determined not by the embodiments illustrated, but by the appended claims and their legal equivalents.

What is claimed is:

1. A toy, the toy comprising:
a toy portion configured to separate into a first toy member, a central spinner, and a second toy member, the first toy member defined by a first end wall, a first continuous sidewall, and a circular recess, the central spinner defined by a middle continuous sidewall and a transversely disposed wall having a generally concentric channel, the central spinner disposed between the first toy member and the second toy member, the second toy member defined by a second end wall and a second continuous sidewall; and
a cord configured to extend between the first end wall of the first toy member and the second end wall of the second toy member, the cord further configured to pass through the channel of the central spinner, the cord further configured to rotatably carry the central spinner, whereby the cord is configured to twist in a first direction to generate torque and rotatably carry the central spinner towards the first toy member, whereby the cord is configured to twist in a second direction to release momentum from the generated torque and rotatably carry the central spinner towards the second toy member.

2. The toy of claim 1, wherein the central spinner has a generally cylindrical shape.

3. The toy of claim 1, wherein the first toy member and the second toy member have a generally frustoconical shape.

4. The toy of claim 1, wherein the first continuous sidewall has a first beveled edge.

5. The toy of claim 4, wherein the second continuous sidewall has a second beveled edge configured to mate with the first beveled edge.

6. The toy of claim 1, wherein the cord is configured to form a continuous loop.

7. The toy of claim 1, wherein the central spinner is rotatably carried towards the first toy member and the second toy member at an angular velocity and a linear velocity.

8. The toy of claim 7, wherein the angular velocity and the linear velocity of the central spinner is increased by drawing the cord taut.

9. The toy of claim 8, wherein the angular velocity and the linear velocity of the central spinner is decreased by slackening the cord.

10. The toy of claim 9, wherein two cords are used and each cord loops from the first continuous sidewall to the second continuous sidewall, whereby the central spinner is centrally balanced in relation to the first toy member and the second toy member when spinning.

11. The toy of claim 1, further including a marking device configured to detachably attach to the toy portion, the marking device further configured to produce a mark.

12. The toy of claim 11, wherein the marking device includes at least one member selected from the group consisting of: a solid pigment core, a solid wax core, or an ink dispenser.

13. The toy of claim 1, further including a generally elongated dispenser defined by a mark end, a cap end, and cavity.

14. The toy of claim 13, wherein the cavity is configured to contain at least one member selected from the group consisting of: a hard candy, a gum, a chocolate, a medicine, a tablet, and a small toy.

15. The toy of claim 14, wherein the dispenser comprises cap end and a mark end.

16. The toy of claim 15, wherein the cap end has a first threaded section, and the mark end has a second threaded region.

17. A toy, the toy comprising:
a toy portion configured to separate into a first toy member, a central spinner, and a second toy member, the first toy member defined by a first end wall, a first continuous sidewall, and a circular recess, the central spinner defined by a middle continuous sidewall and a transversely disposed wall having a generally concentric channel, the central spinner disposed between the first toy member and the second toy member, the second toy member defined by a second end wall and a second continuous sidewall;
a cord configured to extend between the first end wall of the first toy member and the second end wall of the second toy member, the cord further configured to pass through the channel of the central spinner, the cord further configured to rotatably carry the central spinner, whereby the cord is configured to twist in a first direction to generate torque and rotatably carry the central spinner towards the first toy member, whereby the cord is configured to twist in a second direction to release momentum from the generated torque and rotatably carry the central spinner towards the second toy member; and
a generally elongated dispenser defined by a cavity, a cap end, and a mark end, the cap end of the dispenser configured to detachably attach to the toy portion.

18. The toy of claim 17, further including a marking device configured to detachably attach to the toy portion, the marking device further configured to produce a mark.

19. The toy of claim 17, wherein the cap end has a first threaded section, and the mark end has a second threaded region.

20. A toy, the toy comprising:
a toy portion configured to separate into a first toy member, a central spinner, and a second toy member, the first toy member defined by a first end wall, a first continuous sidewall, and a circular recess, the central spinner defined by a middle continuous sidewall and a transversely disposed wall having a generally concentric channel, the central spinner disposed between the first toy member and the second toy member, the second toy member defined by a second end wall and a second continuous sidewall;
a cord configured to extend between the first end wall of the first toy member and the second end wall of the second toy member, the cord further configured to pass through the channel of the central spinner, the cord further configured to rotatably carry the central spinner, whereby the cord is configured to twist in a first direction to generate torque and rotatably carry the central spinner towards the first toy member, whereby the cord is configured to twist in a second direction to release momentum from the generated torque and rotatably carry the central spinner towards the second toy member; and
a generally elongated dispenser defined by a cavity, a cap end, and a mark end, the cap end of the dispenser configured to detachably attach to the toy portion; and a marking device configured to detachably attach to the mark end of the dispenser.
